(19) United States
(12) Patent Application Publication
(10) Pub. No.: US 2006/0261627 A1
(43) Pub. Date: Nov. 23, 2006

(54) Visor and method for making a visor

(75) Inventors: L. Robert Hamelink, Hamilton, MI (US); Jon Frens, Jenison, MI (US); Scott T. Williams, Holland, MI (US); Kirk E. Meyer, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/394,360

(22) Filed: Mar. 30, 2006

Related U.S. Application Data
(60) Provisional application No. 60/667,530, filed on Apr. 1, 2005.

(51) Int. Cl. B60J 3/00

(52) U.S. Cl. 296/97.1

(57) ABSTRACT

A method of making a visor for a vehicle includes providing a mold having a three dimensional cavity, introducing at least one hardware component into the cavity, simultaneously co-extruding a cover layer of material and a core layer of material into the cavity and around the hardware component, inflating the cover and core layers of material within the cavity; and removing the visor from the mold. A visor for a vehicle includes a first panel and a second panel joined together along a common perimeter and having a hollow region therebetween, the first panel and the second panel integrally formed from an inner layer of a structural material and an outer layer of an upholstery material that are coextruded in a blow molding operation.

### CROSS REFERENCE TO RELATED APPLICATIONS

The present Application claims the benefit of priority under 35 U.S.C. § 119(e) to U.S. Provisional Patent Application No. 60/667,530, titled Visor and Method for Making a Visor, filed on Apr. 1, 2005, the disclosure of which is hereby incorporated by reference.

### BACKGROUND

The present inventions relate generally to the field of components such as visors for use in vehicles (e.g., automobiles such as cars, trucks, and the like; airplanes, boats, etc.). More specifically, the present inventions relate to visors formed using a blow molding process. Further, the present inventions relate to visors having a structural layer and a cover layer formed simultaneously by coextrusion in a blow molding process.

Visors for use in vehicles to shield an occupant from sunlight are generally known. Such visors typically have a “butterfly” or “clamshell” type core portion at least partially covered by a cover material such as a fabric. The cover material often “overlaps” or is wrapped over the perimeter edges of the core, portion so that when the core portion is “folded” about a midpoint, the perimeter edges of each half of the core portion meet and the cover material is tucked therebetween to create a “tucked edge” intended to have a “neat” aesthetically attractive appearance.

However, such visors and methods for making the visors have certain disadvantages. For example, when cover materials such as cloth and fabrics are used, the material and labor or equipment costs to tuck the fabric tend to be expensive. By further way of example, when the cover material is a synthetic material such as vinyl or plastic, wrapping the material over the core portion and then folding the core portion tends to create a poor quality appearance having defects such as “wrinkles” around curves or radii of the visor core or other undesirable effects that tend to require additional operations or effort to resolve which may reduce the cost-effectiveness of such cover materials and methods for visor applications.

Other visors may be formed with a structural core portion formed in a blow molding operation. However, such blow molded cores typically do not provide certain desired surface characteristics (e.g. soft-touch, upholstered-feel, aesthetically appealing surface texture and appearance, etc.). Certain blow molded cores may be covered with an over-molded material to provide the desired surface characteristics to the visor. However, adhesives and other fasteners for attaching the cover to the core are subject to eventual separation, and most visors tend to be relatively low cost production items and such additional manufacturing processes tend to add cost and delay to production of the visors.

Accordingly, there is a need to provide a method for producing components such as visors for use in vehicles that includes an inner “structural” core material (e.g. polypropylene, polyurethane, etc.) and an outer “cover” material (e.g. vinyl, santoprene, etc.). There is also a need to provide a method for forming the visor core and visor cover material simultaneously in a single manufacturing operation such as blow molding with co-extruded materials. There is also a need to provide a method of forming a visor with a cover material having multiple colors or surface textures. There is also a need to provide visors and a method for making visors that may be manufactured in a relatively simple and efficient manner with reduced manufacturing and material costs. There is also a need to provide a manufacturing method for producing visors having a rigid core and soft cover that permits accessories (e.g. vanities, lamps, clips, pivot rods, brackets, slide mechanisms, etc.) to be integrally formed with the visor core during the blow molding operation.

Accordingly, it would be desirable to provide a component such as a visor having any one or more of these or other advantageous features.

### SUMMARY

A visor for a vehicle includes a visor body formed from at least two layers of co-extruded materials in a blow molding operation, where a first layer is a substantially resilient material that forms a cover layer for the visor and the second material is a generally rigid material that forms a core portion of the visor. Internal components such as mounting brackets, torque or detent springs/clips may be integrally formed within the co-extruded layers of material during the molding operation.

A method of making a visor for a vehicle includes providing a mold having a three dimensional cavity, introducing at least one hardware component into the cavity, simultaneously co-extruding a cover layer of material and a core layer of material into the cavity and around the hardware component, inflating the cover and core layers of material within the cavity, and removing the visor from the mold. The method also includes installing accessories on the visor. The method also includes removably attaching a hardware element to a blow pin for positioning the hardware element within the cover layer and core layer.

A visor for a vehicle also includes a first panel and a second panel joined together substantially along a common perimeter and having an open cavity therebetween. The first panel and second panel are integrally formed from an inner layer of a structural material and an outer layer of an upholstery material. At least one of the first panel and the second panel may be formed with a suitable recess for receiving a visor accessory (e.g. vanity pack, ticket clip, remote control device). A hardware element may be integrally formed within the cavity and secured to the inner layer. The inner layer and the outer layer are co-extruded and integrally formed in a blow-molding operation.

### BRIEF DESCRIPTION OF THE DRAWINGS

FIG. 1 is a schematic representation of a perspective view of a visor for use in a vehicle according to an exemplary embodiment.

FIG. 2A is a schematic representation of a perspective view of a visor for a vehicle formed in a blow molding operation according to an exemplary embodiment.

FIG. 2B is a schematic representation of a cut-away perspective view of a visor for a vehicle formed in a blow molding operation according to an exemplary embodiment.

FIG. 2C is a schematic representation of a cross sectional view of a visor for a vehicle formed in a blow molding operation according to an exemplary embodiment.

FIG. 3A is a schematic representation of a co-extrusion blow molding operation with mold open for forming a visor to an exemplary embodiment.

FIG. 3B is a schematic representation of a co-extrusion blow molding operation with mold open for forming a visor to an exemplary embodiment.

FIG. 3C is a schematic representation of a co-extrusion blow molding operation with mold open for forming a visor to an exemplary embodiment.

FIG. 3D is a schematic representation of a co-extrusion blow molding operation with mold closed for forming a visor to an exemplary embodiment.

### DETAILED DESCRIPTION

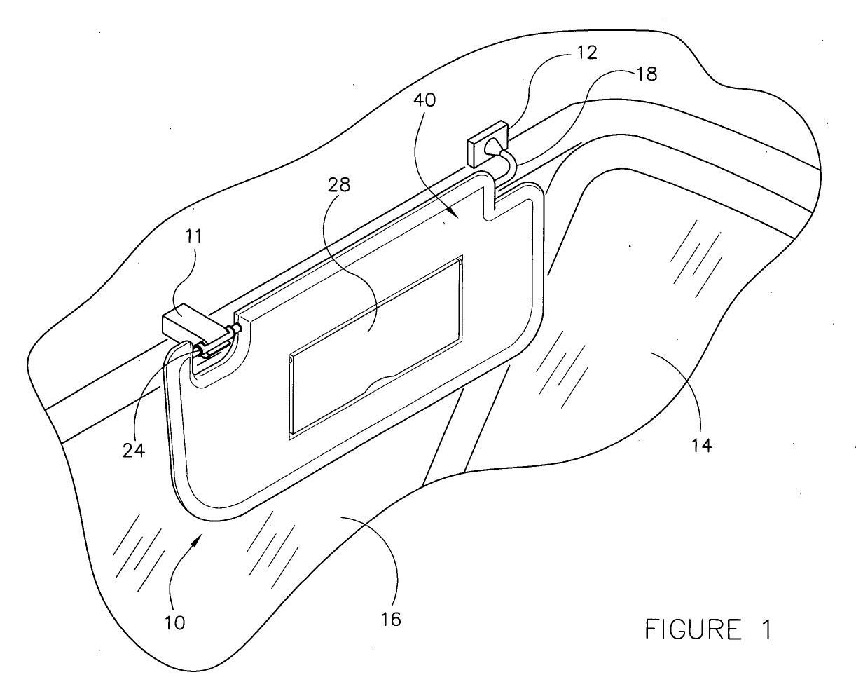

FIGS. 1-3D illustrate one exemplary embodiment of a component or assembly such as a visor for use in a vehicle (e.g., automobiles such as cars, trucks, sport utility vehicles, minivans, buses, and the like; airplanes, boats, etc.). Such components may be provided in a wide variety of sizes, shapes, and configurations, and with various accessories or hardware for adapting the visor for use in the vehicle or improving its functionality according to various exemplary embodiments. All such configurations are intended to be within the scope of the inventions.

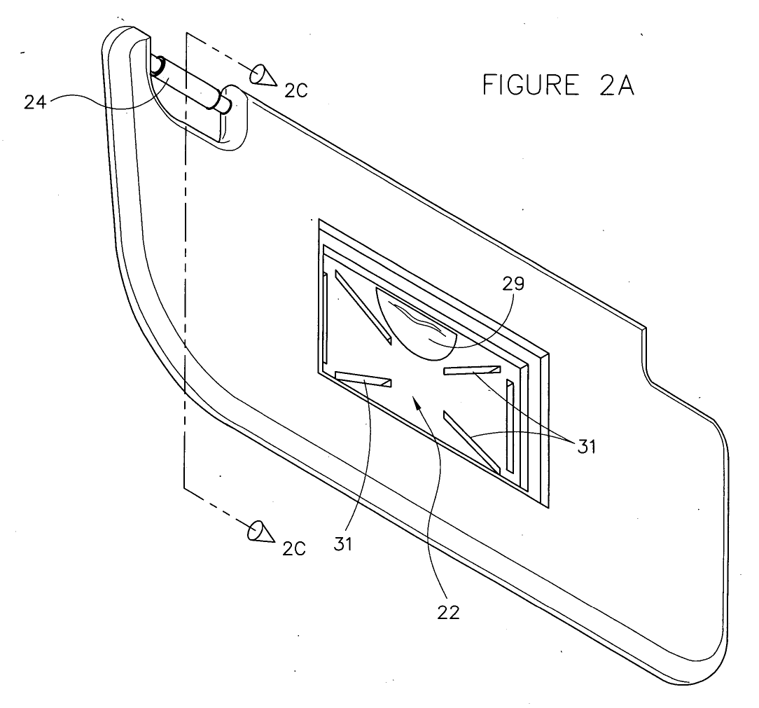

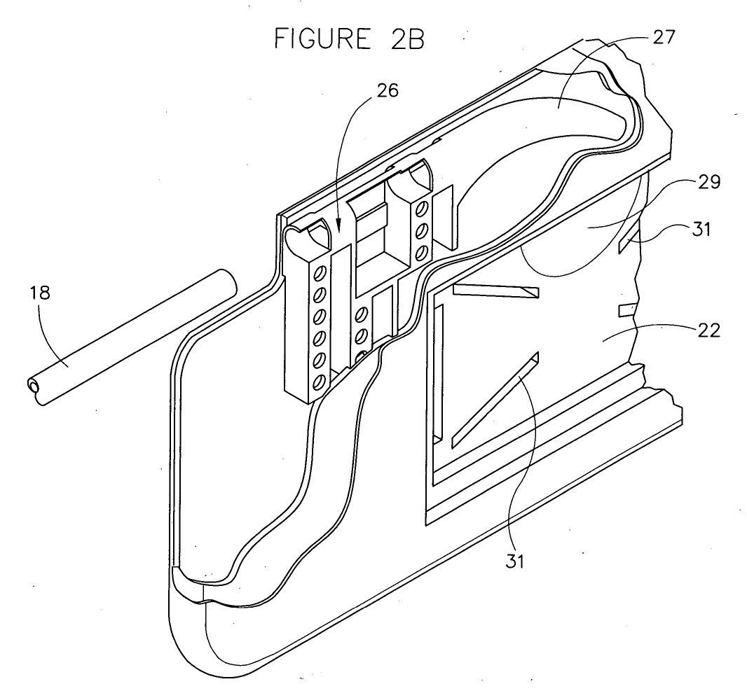

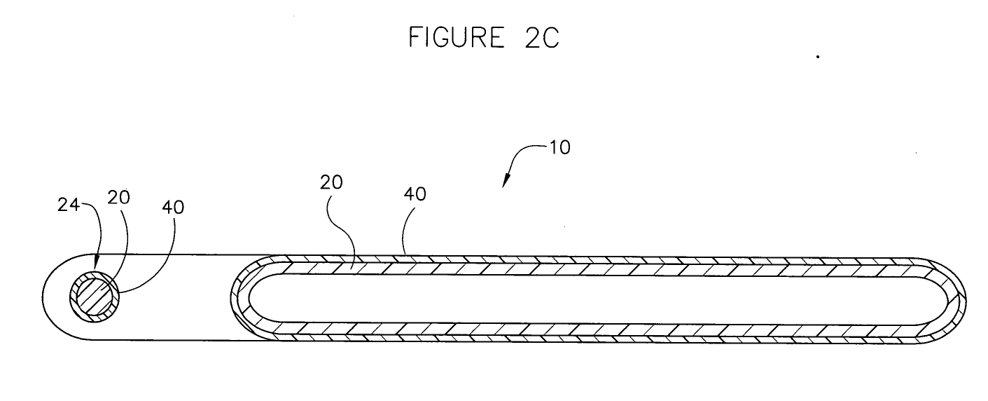

Referring to FIGS. 1 and 2A-2C, a component shown as a visor 10 is shown having a substrate (shown as core portion 20) and a cover layer (shown as a film or skin 40). According to a preferred embodiment, core portion 20 is formed from a plastic material such as plastic, PVC, polyethylene, polypropylene, copolymers, etc. The region of the core portion along the “top” of the visor may be provided with a mounting bracket 12 for mounting the visor to a vehicle. The mounting bracket 12 is shown coupled to suitable structure (e.g. pivot rod, slide mechanism, torque clip, etc.) for operation of the visor through the desired range of motions configured to permit a desired operation of the visor 10, such as swiveling between a lateral side window 14 position and a forward windshield 16 position, sliding between a retracted and an extended position, rotating between an upper nonuse position and a lower sun-blocking position, etc.

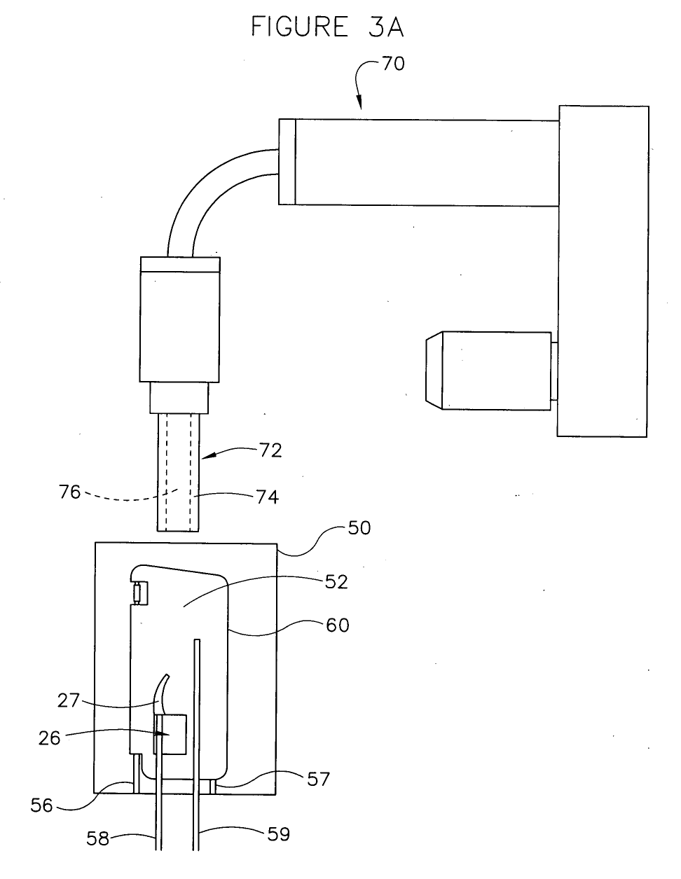

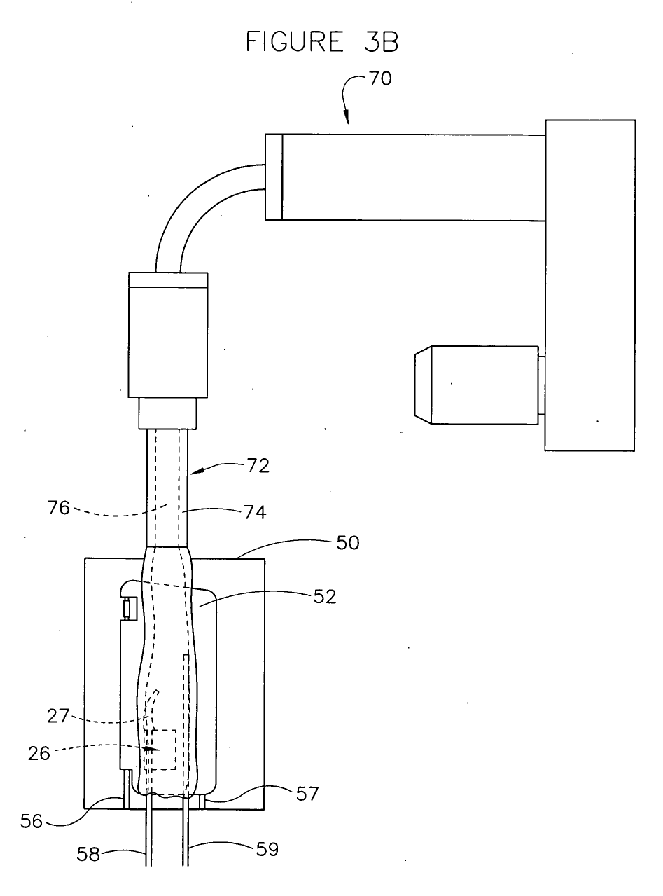

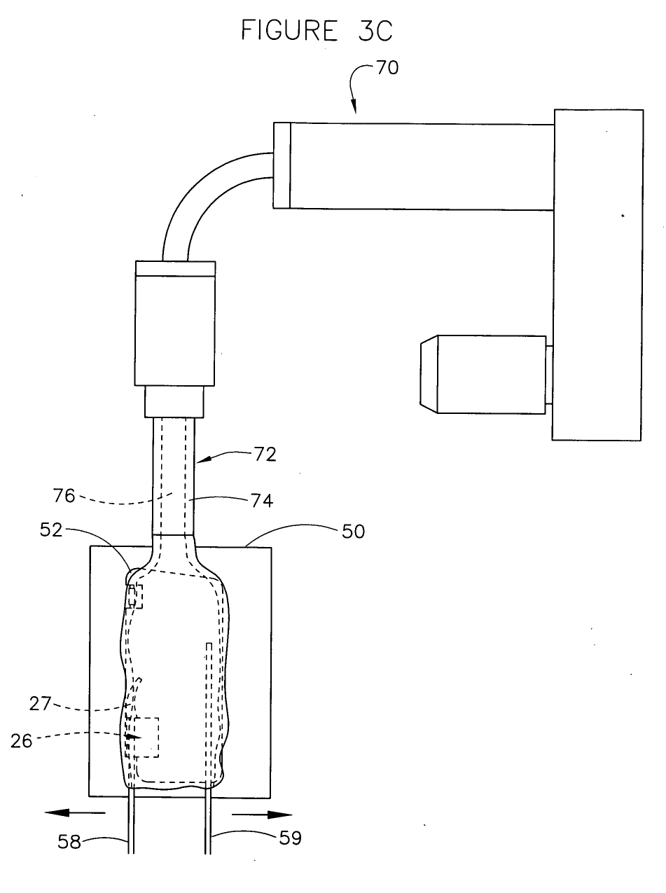

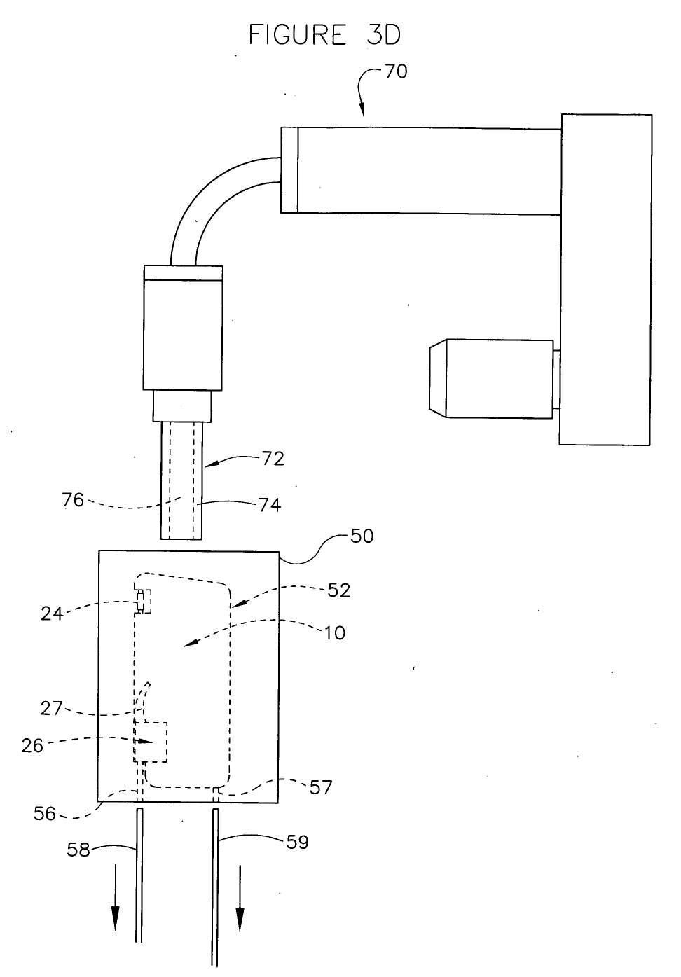

Referring to FIGS. 3A-3D, visor 10 is shown formed in a single-operation co-extrusion blow molding process, according to an exemplary embodiment. A blow mold 50 (having two mold halves, for example, with the face of one mold half shown) is provided having a cavity 52 in the form of a body for the visor 10 and preferably includes integral cooling (e.g. air or liquid cooling, etc.). The cavity 52 is a three dimensional space that may include any suitable contour for forming the body of the visor 10 and to receive accessories such as a recess 22 shown in FIG. 2A for receiving a vanity pack 28 (shown in FIG. 1) etc. or molded-in structures (such as a pin 24 (sometimes referred to as a “Europin”) as shown in FIG. 2B, the pin configured to releasable engage a bracket 11 in the vehicle for retaining the visor in a forward position) or having a suitable space for receiving “internal” components (such as a pivot rod carrier bracket and torque clip assembly 26 shown in FIG. 2B). The cavity may also be formed with other structures to enhance the utility of the visor. For example, the recess 22 may also be formed with a feature shown as an access point 29 (e.g. a cut-out location, or a bubble, or a knock-out panel, etc.) that may be pierced, cut or slit for routing wires (not shown) from vanity pack 28 through the hollow internal core of the visor to a power source (e.g. such as wires extending through a hollow pivot rod, etc.). The cavity may also include ribs or other suitable projections that result in the formation of stiffening ribs 31 within the walls of the visor.

When mold 50 is “open” (see FIGS. 3A-3C) a sufficient space is created between the mold halves for cavity 52 to receive the co-extruded materials for forming the visor. An opening 56 is provided in mold 52 to accommodate an inflator device (shown as a retractable blow pin 58) and another opening 57 is provided to accommodate a retractable parison handling device (shown as a stretch pin 59) within the co-extruded materials in cavity 52. According to one embodiment, the blow pin 58 and stretch pin 59 are initially positioned adjacent to one another between the mold halves and the material layers 74, 76 of a parison 72 are co-extruded over both pins 58 and 59. The blow pin 58 and stretch pin 59 are then drawn away (e.g. apart, etc.) from one another to a final position (corresponding to openings 56 and 57) to stretch the parison 72 for enhanced material coverage within the mold cavity. According to the illustrated embodiment, the final position of the blow pin 58 corresponds generally to the location of the opening in the visor body along the top edge, through which the pivot rod for the visor is subsequently installed. The mold halves are then closed to permit introduction of a gas for expanding the co-extruded materials in the mold cavity.

Openings 56 and 57 may be located along a parting line of blow mold 50, or at any other suitable location to provide the desired performance of the blow mold operation. After parison 72 is extruded into cavity 52, the mold halves provide a closed edge (e.g. parting line, etc.) around the perimeter of the visor, with opening 56 for retracting blow pin 58 and for inserting other visor components (e.g. pivot rods for pivotally mounting the visor to a vehicle, etc.), and opening 57 for retracting stretch pin 59. According to an alternative embodiment, the blow mold may be formed in any suitable number of segments for molding the desired three dimensional features of the visor. Also, additional openings may be provided in the mold. For example, the mold may be closed and then the co-extruded materials may be injected through a separate opening in the mold.

The blow pin 58 is formed with a hollow passage for inflating the co-extruded materials and is formed with a receiving structure for holding internal components of the visor during the molding operation. According to the illustrated embodiment, the blow pin 58 is configured to releasably receive and hold visor hardware shown as a pivot rod carrier bracket and torque spring or clip assembly 26 for rotatably and/or slidably engaging a pivot rod 18 for a mounting bracket 12 (see FIG. 1). The receiving structure on the blow pin 58 may have any suitable form for retracting the blow pin after formation of the visor (e.g. interference fit, detent fit, sliding fit, etc.). The receiving structure may be configured to receive the internal components manually or in an automated (e.g. robotic, etc.) assembly operation.

Referring further to FIGS. 3A-3C, the halves of the blow mold 50 are opened and a blow molding machine 70 co-extrudes a multi-layer concentric “tube” of molten material in a single parison 72 into the cavity. Blow molding machine 70 is intended to be a conventional type machine configured to co-extrude multiple layers of materials and typically includes an extruder for each material layer that includes a hopper for delivering pellets of the layer of material to a screw having a compression section that melts or plasticizes the pellets of the material, and a metering section that regulates the amount of material extruded. The molten materials from each extruder are extruded together through a die assembly and into a parison. The parison 72 is shown having dual layers; a first outer layer 74 includes the material for the cover layer 40 of the visor 10 and the second, inner layer 76 includes the material for the core portion 20. The parison 72 is extruded into the cavity 52 of the blow mold 50 and over the outside of the blow pin 58 and the internal component(s) 26 attached to the blow pin, and the stretch pin 59. The halves of the blow mold 50 are closed and air (or other suitable gas) is introduced through a hollow passage in blow pin 58 to inflate the dual layers of the parison 72 against the walls of the cavity 52 and around internal component(s) 26 (see FIG. 3D) to form the visor 10. Blow pin 58 also serves the dual purpose providing a releasable holder for positioning visor hardware 26 or other components within cavity 52 and parison 72.

According to the illustrated embodiment, the internal component or assembly 26 is shown to include a flow director (shown as a flow nozzle 27) that is configured to direct the flow of air from the blow pin, through the component and toward the center of the cavity of the mold. The flow director 27 is intended to enhance the performance of the blow molding operation when the final position of the blow pin is located non-centrally with respect to the mold (e.g. along a top edge so that the hole formed by the blow pin corresponds with the opening for the visor pivot rod). After the dual layers of material 74, 76 have sufficiently cooled, the blow mold 50 opens and the visor 10 is removed and trimmed, with components or assembly 26 integrally formed within the visor body. Additional components (e.g. bezels, pivot rods, mounting brackets, clips, etc.) or accessories (e.g. a vanity mirror 28 as shown in FIG. 1, advisory or informational labels, etc.) may then be attached to (or inserted into) the visor. According to alternative embodiments, any suitable type of blow molding machine capable of simultaneously co-extruding at least two layers of material in molten form may be used to form the visor.

The co-extrusion of the core portion material with the cover layer material in a single parison (e.g. concentrically, etc.) and blow molding the two materials simultaneously in a single or “one-shot” operation is intended to provide a single-piece visor having complex shapes and features, with both rigid and flexible characteristics. According to a preferred embodiment, the core portion 20 is a generally rigid and hard component that provides an underlying frame or structure and the cover layer 40 is a soft and resilient material (e.g. “soft-touch”) that provides an overlying upholstery layer that has the desired appearance, texture and cushioning characteristics.

According to any exemplary embodiment, the core portion may be molded in any suitable shape and size to suit an intended application and to receive certain desired components or hardware, etc. after completion of the molding process (e.g. by snap-fit connection, adhesive, heat-stake, etc. The core portion may also be configured for integral formation with certain components or hardware during the molding process by placing the components or hardware within the mold and forming the core and cover of the visor around the components or hardware. According to any exemplary embodiment, the components may include any one or more of accessories such as remote control devices (e.g. Homelink®, etc.), vanity packs (e.g. mirrors, illumination devices, sliding or hinged covers, storage compartments, etc.), Euroclips, ticket clips, electronics, audio components, etc. The hardware may also include pivot rods (with or without a slide mechanism), torque clips, mounting brackets, etc.

The cover layer 40 is configured to cover an outer surface of the core portion 20 to provide a finished appearance that may be custom-suited to a decorative trim or finish scheme for the interior of the vehicle. According to a preferred embodiment, the material of the cover layer of the dual layer parison 72 is made of a relatively soft and pliable material such as vinyl, Santoprene®, a thermoplastic olefin (TPO), a plastisol, etc. The cover layer may be formed in the mold so that certain contours, cutouts, etc. are provided to permit installation of the accessories on the visor after the visor is removed from the mold to create a neat “finished” appearance. The mold may also have various surface treatments to impart desired features on the surface of the cover material (such as textures, the appearance of a “tucked edge” along a perimeter, etc. The textures may be generally uniform on the cover material, or variations in texture may be provided (e.g. a first texture on a first side of the visor and a second texture on a second side of the visor, etc.).

According to an exemplary embodiment in which the cover layer is made of a polymeric material, the cover layer has a thickness sufficient to provide a durable surface for the visor such as between approximately 0.2 and 5.0 millimeters, and most preferably between approximately 0.5 and 3.0 millimeters.

According to any embodiment, the core portion and cover material may have a size, shape, and configuration that is adapted or configured to suit any particular visor application for an intended vehicle. Any number of components may be included in the mold for integration with the visor during the molding process, and the visor may be formed with any suitable recesses or other structure for receiving a desired set of accessories, and the surfaces of the cover material may be provided with any suitable texture or combination of textures to create a desired appearance and feel. The size, shape, and configuration of the core and cover layer may have any number of forms, and relatively complex geometries may be formed. One of skill in the art will appreciate that various possibilities exist in this regard.

According to an alternative embodiment, an additional layer of material, such as a “cushioning” material may be extruded between the outer surface of the core portion material and the inside of the cover material layer to provide a more enhanced “padded” or “cushioned” appearance and/or feel, the cushioning may also serve to improve the performance of the visor in the event of impact by the head of an occupant. The particular design chosen may depend on any of a variety of factors, including the desired look and feel of the outer surface of the visor, materials costs, ease of manufacturing, etc.

According to any preferred embodiment, a visor and method of making a visor are provided by co-extruding a first structural material and a second cover layer material into a mold cavity having the desired three dimensional shape and surface texture characteristics, positioning the desired hardware and/or accessories within the mold cavity (such as by removable attachment to the blow pin) and pressurizing or inflating the layers of co-extruded materials against a mold cavity in a blow molding process.

The construction and arrangement of the elements of the visor for a vehicle as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements of hardware and accessories, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the visor may be constructed from any of a wide variety of materials that provide sufficient strength or durability, including any of a wide variety of moldable plastic materials (such as high-impact plastic for the core and pliable materials for the cover) in any of a wide variety of colors, textures and combinations. Other substitutions, modifications, changes and omissions may be made in the design, operating conditions and arrangement of the preferred and other exemplary embodiments without departing from the scope of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present inventions as expressed in the appended claims.

What is claimed is:

1. A visor for a vehicle, comprising:
a visor body formed from at least a first layer and a second layer of co-extruded materials in a blow molding operation;
the first layer comprising a substantially resilient material that forms a cover layer for the visor and the second material comprising a generally rigid material that forms a core portion of the visor; and
at least one internal component integrally formed with the first layer and the second layer during the molding operation.

2. The visor of claim 1 wherein the internal component comprises at least one of a mounting bracket, a torque spring, a detent clip.

3. The visor of claim 2 wherein the internal component further comprises a flow nozzle configured to direct a flow of a gas during the blow molding operation.

4. The visor of claim 1 wherein the first layer and second layer are formed with a recess configured to receive a vanity.

5. The visor of claim 1 wherein the recess further comprises a location configured to permit passage of wires for the vanity.

6. The visor of claim 1 wherein the visor body is formed with an opening designed to accommodate both a blow pin from the blow molding operation and installation of a visor pivot rod.

7. The visor of claim 1 wherein the visor body formed during the blow molding operation further comprises at least one stiffening rib integrally formed therein.

8. A method of making a visor for a vehicle, comprising:
providing a mold having a three dimensional cavity;
introducing at least one hardware component into the cavity;
simultaneously co-extruding a cover layer of material and a core layer of material into the cavity and around the hardware component;
inflating the cover and core layers of material within the cavity; and
removing the visor from the mold.

9. The method of claim 8 further comprising the step of installing accessories on the visor.

10. The method of claim 8 further comprising the step of removably attaching a hardware element to a blow pin for positioning the hardware element within the cover layer and core layer.

11. The method of claim 10 wherein the hardware element comprises a flow director configured to direct flow from the blow pin for pressurizing the cavity.

12. The method of claim 8 further comprising the step of providing a retractable blow pin and a retractable stretch pin configured to interact with the cavity.

13. The method of claim 12 wherein the blow pin and the stretch pin are movable from an initial position to a final position to expand the cover layer of material and the core layer of material in the cavity after the step of co-extruding and before the step of inflating.

14. The method of claim 13 wherein the blow pin in the final position is located adjacent a top edge of the visor so that an opening in the visor formed by the blow pin corresponds to an installation location for a pivot rod for the visor.

15. A visor for a vehicle, comprising:
a first panel and a second panel joined together substantially along a common perimeter and having a hollow region therebetween, the first panel and the second panel integrally formed from an inner layer of a structural material and an outer layer of an upholstery material that are coextruded in a blow molding operation;
wherein at least one of the first panel and the second panel are formed with a recess for receiving a visor accessory.

16. The visor of claim 15 wherein the visor accessory comprises at least one of a vanity pack, a ticket clip, and a remote control device.

17. The visor of claim 16 wherein the recess further comprises an access point configured to permit passage of wires from the vanity pack.

18. The visor of claim 15, further comprising a hardware element integrally formed within the hollow region and secured to the inner layer during the blow molding operation.

19. The visor of claim 17 wherein the hardware element comprises a flow device configured to direct a flow of a gas during the blow molding operation.

20. The visor of claim 15 wherein the first layer and second layer are formed with an opening designed to accommodate both a blow pin from the blow molding operation and installation of a visor pivot rod.

21. The visor of claim 15 wherein at least one of the first layer and the second layer comprise a stiffening rib integrally formed therein during the blow molding operation.

22. The visor of claim 15 wherein the hollow region is shaped to form a pin along a top edge of the visor, the pin configured to releasably engage a bracket on a vehicle.
